(19) United States
(12) Patent Application Publication
(10) Pub. No.: US 2016/0081872 A1
(43) Pub. Date: Mar. 24, 2016

(54) SPINAL TRACTION APPARATUS AND METHOD

(71) Applicant: Serafin Samson, Maple Grove, MN (US)

(72) Inventors: Serafin Samson, Maple Grove, MN (US); Kirk Robert Schneider, Chaska, MN (US)

(21) Appl. No.: 14/844,302

(22) Filed: Sep. 3, 2015

Related U.S. Application Data
(60) Provisional application No. 62/045,934, filed on Sep. 4, 2014.

(51) Int. Cl. A61H 1/02

(52) U.S. Cl. CPC A61H 1/0292

(57) ABSTRACT

A human spinal traction apparatus can include a platform. The platform can extend longitudinally between first and second ends. The platform can be sized, shaped, or otherwise configured to accommodate at least a portion of an average adult human user's torso resting prone upon the platform when the user's pelvis is located adjacent the first end of the platform. A pelvic brace can be positioned and oriented with respect to a first end of the platform so as to inhibit or prevent movement of the user's pelvis in a longitudinal direction along the platform when the portion of the user's torso is resting prone upon the platform. An upper body engagement member can be sized, shaped, or otherwise configured to engage a portion of an upper body of the user in a manner that is capable of allowing traction extending the user's spine in a longitudinal direction along the platform.

### CROSS REFERENCE TO RELATED APPLICATIONS

This application claims the benefit of priority to U.S. Provisional Patent Application Ser. No. 62/045,934, filed Sep. 4, 2014, the content of which is incorporated herein by reference in its entirety.

### BACKGROUND

Every year in the United States, about 30 million individuals report back pain. Even after receiving conservative therapy, annually about 4.5 million individuals continue to experience back pain. Annually, about 1.5 million individuals receive minimally invasive therapy (e.g., epidural steroid injections (ESI)). About 1 million annually are monitored for back pain. Annually, about 450,000 individuals undergo some sort of surgical spinal treatment procedure.

U.S. Pat. Pub. No. 2011/0319934 to Roland Berthiaume, filed on Jun. 25, 2010, entitled SIMPLE PORTABLE LUMBAR SPINE DISTRACTION DEVICE AND METHOD is directed toward a simple, lightweight, portable, lumbar spinal distraction device, such as can be used to help alleviate back pain.

U.S. Pat. No. 7,108,671 to H. Duane Saunders, issued on Sep. 19, 2006, entitled PORTABLE LUMBAR TRACTION DEVICE is directed toward a portable lumbar traction device, with FIG. 8 showing a patient lying on his or her back on a support surface (152) having a carriage (154) slidable along a longitudinal axis. A restraining mechanism (e.g., pelvic belt (142)) releasably restrains a portion of a patient's body to the carriage (154). A pneumatic cylinder (32) can be pressurized to create a traction force “F”.

U.S. Pat. No. 5,971,901 to George B. Shaw, issued on Oct. 26, 2999, entitled EXERCISE MACHINE is directed toward an exercise apparatus that uses gravity to create a gentle tension on the lower back, with FIG. 2 showing the user suspended above a seat by a reclining back support and a horizontal bar under the posterior of the user's legs behind the user's knees.

Hammacher Schlemmer's website shows THE GENTLE MOTION STANDING BACK STRETCHER, Item 82006 (http://www,hammacher.com/Product/82006?promo=search (visited on 24 Jan. 2013)), which shows an apparatus that is intended to gently relieve lower-back and mid-back discomfort and stiffness without requiring the user to kneel on the floor. In a standing position, the user grasps a pair of handles on assembly that rotates forward as the user bends forward, with a waist support blocking forward motion of the user's waist, hips, and legs. Armpit braces on the assembly are positioned behind the user's armpits. As the user bends forward, a traction force on the user's spine is passively created by the user's upper body weight as the user bends forward while the user's waist, hips, and legs are being restrained by the waist support.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an isometric view of the first example of a traction apparatus comprising a torso support platform, pelvic brace, and an engagement member, which are supported on a structural frame.

FIG. 2 shows an isometric view of the second example of the apparatus comprising elements of the first example combined with the addition of a sliding platform.

FIG. 3 shows an isometric view of the third example of the apparatus comprising elements of the first and second examples combined with the addition of a pivoting platform, engagement members, and frame members.

FIG. 4 shows an isometric view of a fourth example of the apparatus comprising elements of the first through third examples combined with the addition of a face rest.

FIG. 5 shows an isometric view of a fifth example of the apparatus comprising elements of the first through fourth examples combined with the addition of a mechanical linkage which displaces the position of the brace when the engagement members are actuated.

FIG. 6 shows an isometric view of a sixth example of the apparatus comprising elements of the first example though fifth example combined with the addition of a pivoting base assembly.

### DETAILED DESCRIPTION

The following description describes an apparatus and method that can be used for providing tension (traction) to the spine of an individual such as while he or she is positioned in a prone orientation.

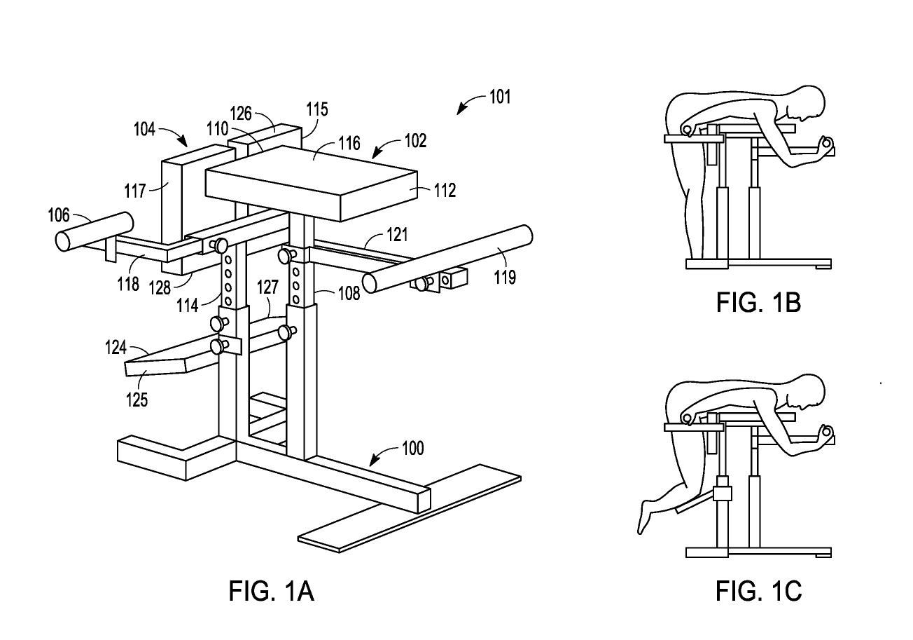

FIG. 1 shows an example of a traction apparatus, such as a human spinal traction apparatus 101. The traction apparatus 101 can include a free-standing or other frame 100. The traction apparatus 101 can also include a fixed, adjustable, sliding or other platform 102, a brace 104, and an engagement member 106. The platform 102 can be attached to the frame 100, such as by an adjustable member 108. The adjustable member 108 can allow a user to select a height position from multiple available height positions. For example, the adjustable member 108 can include a shaft arranged to be capable of sliding with respect to a sleeve, such as within a lumen of the sleeve. A series of holes can be drilled through the shaft and sleeve at alignable positions. A pin can be inserted therethrough, such as to set the height of the platform 102 at a desired one of the available height positions.

Additional or alternative examples of ways of implementing a height adjustment of the platform 102 can include one or more of: (1) a shaft arranged to be capable of sliding within a sleeve such that the shaft can be held in an infinite or continuous number of positions (e.g., such as using a friction lock, such as a set screw), or (2) a pneumatic cylinder with an adjustable volume setting. The platform 102 can be user-adjusted to a desired height. For example, the desired height permit the user to be suspended off the floor such as with the user's legs extending vertically downward when user's torso is resting prone on the platform 102. In an example, the platform 102 height above the floor can be adjusted within a range such as between a minimum height of 50 centimeters up to a maximum height of 150 centimeters. The frame 100 can be sized to provide enough of a base width to prevent the traction apparatus 101 from tipping. In an example, the traction apparatus 101 can include a width-to-height ratio of between 0.5 and 2.0, such as a width-to-height ratio of 0.5, 1.0, 1.5, or 2.0. In an example, the frame 100 can be fixedly attached to the floor.

The platform 102 can extend longitudinally between a first end 110 of the platform 102 and second end 112 of the platform 102. The platform 102 can have a size and shape that can be selected to be capable of supporting at least a portion of an average size human, such as with such portion in the prone position. This can include, for example, being sized and shaped to support the user's torso prone upon the platform 102, such as to provide suitable stability and enough weight distribution during the traction to avoid discomfort. In one example, the platform 102 can be sized and shaped to off-load the user's spine along the longitudinal axis of the spine. Configuring the platform to support at least a portion of an average size human in the prone position can include sizing the platform 102 to define a surface area that can be within a range of 900 square centimeters up to 1,500 square centimeters, a range of 1,500 square centimeters up to 2,500 square centimeters, a range of 2,500 square centimeters up to 5,000 square centimeters, or a range of 5,000 square centimeters up to 8,000 square centimeters. Configuring the platform to support at least a portion of an average size human in the prone position can include sizing the platform 102 such as to have a width in a range of 30 centimeters up to 50 centimeters, a range of 50 centimeters up to 80 centimeters, or a range of 80 centimeters up to 100 centimeters. Configuring the platform 102 to support at least a portion of an average size human in the prone position can include sizing the platform 102 to have a length in a range of 40 centimeters up to 60 centimeters, a range of 60 centimeters up to 80 centimeters, or a range of 80 centimeters up to 100 centimeters. Configuring the platform 102 to support at least a portion of an average size human in the prone position can include providing a length/width ratio in a range of 2.0 to 3.0, a range of 3.0 to 4.0, a range of 4.0 to 6.0, or a range of 6.0 to 8.0. The platform 102 can be padded, such as to provide comfort when supporting the torso or other portion of the user.

The brace 104 can extend laterally along a first end 110 of the platform 102, such as from a first side 115 to a second side 117 of the brace 104. The brace 104 can have a size and shape that can be capable of engaging and bracing an average user's upper thighs or hips, such as to provide suitable stability and enough weight distribution to avoid discomfort during a traction maneuver. The brace 104 can include a size and shape, such can include a width between the first side 115 and the second side 117 that can be in a range of 10 centimeters wide to 30 centimeters wide, a range of 30 centimeters wide to 60 centimeters wide, or a range of 60 centimeters wide to 100 centimeters wide. The width of the brace 104 can be user adjustable, such as by providing two separate portions with a user extendable/retractable support therebetween. The brace 104 can have a height-to-width ratio that can be in a range between 1.0 and 4, such as a height-to-width ration of 1, 2, 3, or 4. In an example, the brace 104 can include padding.

The brace 104 can be attached to the frame 100, such as being adjustably attached by a frame member 114. In an example, the frame member 114 can be extendible and retractable or can otherwise allow translation such as in a direction that can be approximately perpendicular to the platform 102. The frame 100 can support the brace 104 and the platform 102, such as to permit the brace 104 to be located adjacent to the first end 110 of the platform 102. The brace 104 can be arranged in an orientation that can be approximately perpendicular to the platform 102, such as within 30 degrees of perpendicular, within 20 degrees of perpendicular, or within 10 degrees of perpendicular. In an example, the brace 104 can be attached to the frame 100 by the same frame member 108 that can attach the platform 102 to the frame 100. The brace 104 can be used as a pelvic brace during traction, such as to inhibit or prevent the motion of a user's pelvis in the longitudinal direction of the platform 102 (e.g., along the longitudinal axis of the user's spine), such as while the platform 102 slides or otherwise moves in a longitudinal direction away from the brace 104. In an example, the location and configuration of the brace 104 with respect to the platform 102 can be arranged such as to permit the user to stand beside the frame 100 while facing or pressed against the brace 104, such as to permit the user to bend at the waist to rest his or her torso prone on top of the platform 102.

An engagement member 106 can be fixedly or adjustably attached to the frame 100, such as by a frame member 118. The engagement member 106 can be user-attachable to the frame 100, such as at a selected one of multiple available locations, such as to facilitate different positions of use. In an example, one or more engagement members 106 can be attached near the first end 110 of the platform 102. Additionally or alternatively, another engagement member 119 can be located opposite the first end 110 at which the brace 104 is located. One or both of the engagement members 106, 119 can be user-adjustable, such as without requiring the use of a tool or implement. The engagement member 106 can be sized, shaped, or otherwise configured to engage (or be engaged by) a portion of the user's upper body, such as in a manner than can facilitate traction of the user's spine, such as by allowing the user to exert force on the engagement member 106. In an example, the engagement member 106 can include handles that can be located at or near the first end 110 of the platform 102. The handles can be sized, shaped, arranged, or otherwise configured to a length and cross-section such that the majority of the average user's hand is able to wrap around the handle. For example, the handles can be in a range of 10 centimeters to 30 centimeters in length and in a range of 1 centimeter to 6 centimeters in diameter. The user can grip the handles, such as while the user's pelvis is restrained against the brace 104. By pulling on the handles while the user's pelvis is restrained against the brace 104, the user can exert a traction force on the user's spine. The application of force can be substantially toward the user's pelvis, such as in a direction that can be in a range of 0 degrees to 45 degrees from the horizontal, along the longitudinal axis of the user's spine, or other plane of the platform 102. The engagement member 106 (or additionally or alternatively the engagement member 119) can include a plurality of handles such as to accommodate various hand grip locations, positions, or sizes, or any combination thereof. The engagement member 106 can additionally or alternatively be configured to permit engagement of one or more other portions of the user's upper body, such as under the user's arms, behind the user's arms, or inside of the user's forearms. In an example, the engagement member 106 can be a size such as can have a length that can be in a range between 10 centimeters and 50 centimeters and a width that can be in a range between 5 centimeters and 30 centimeters. The engagement member 106 can be shaped to fit comfortably against one or more of the contours of the user's body, such as being shaped to include a portion that can be cylindrical, semi-circular, rectangular, or another shape capable of engaging the user's body. The engagement member 106 can include padding.

A rest platform 124 can be rigidly or adjustably attached to the frame 100. The rest platform 124 can be sized, shaped, located, or otherwise configured to permit the user to rest thereupon at least a portion of the user's lower extremities, such as the user's knees or feet. The rest platform 124 can extend longitudinally, such as in a direction that can be perpendicular to the longitudinal direction of the platform 102, such as between a first end 125 of the rest platform 124 and a second end 127 of the rest platform 124. The rest platform 124 and can be sized, shaped, or otherwise configured such as to be approximately at least the width of an average user's feet, or wider. The rest platform 124 height can be adjusted, such as within a height range that can be from 0 centimeters up to 100 centimeters from the ground, floor, or other surface upon which the frame 100 rests. For example, the height of the rest platform 124 can be adjusted by inserting a pin through a hole on a mount portion associated with the rest platform 124 and an aligned hole on the frame member 114, which can be selected from a plurality of holes providing varying height options. The angle of the rest platform 124 can be adjusted. For example, the angle of the rest platform 124 can be in a range from 0 degrees to 45 degrees from a horizontal plane that is parallel to the floor or other surface upon which the frame 100 can rest. In an example, the rest platform 124 can be adjusted without requiring the use of a tool or implement to hold the rest platform 124 in a fixed position. For example, a threaded bolt can be passed through a hole in the rest platform 124 that can be aligned with a selected one of a plurality of holes in the frame member 112. The bolt 142 can be used to apply a frictional force between a portion of the rest platform 124 and a portion of the frame member 112, such as by tightening the bolt 142. The bolt 142 can be configured to have a molded handle, such as can permit user-adjustment without requiring a tool. In an example, an interface between the rest platform 124 and the frame member 114 can include a radial (or other) pattern tongue and groove geometry, such as can detain or interlock the rest platform 124 at a selected one of a plurality of predefined angles, which can be locked into position such as by using the threaded bolt 142.

One or more portions of the platform 102, the brace 104, the engagement member 106, the engagement member 119, or the rest platform 124 can include padding. The padding can be covered. The padding covering can be selected to provide one or more desired properties, such as durability, anti-microbial capability, texture or “grip”, or other desired property or combination of properties.

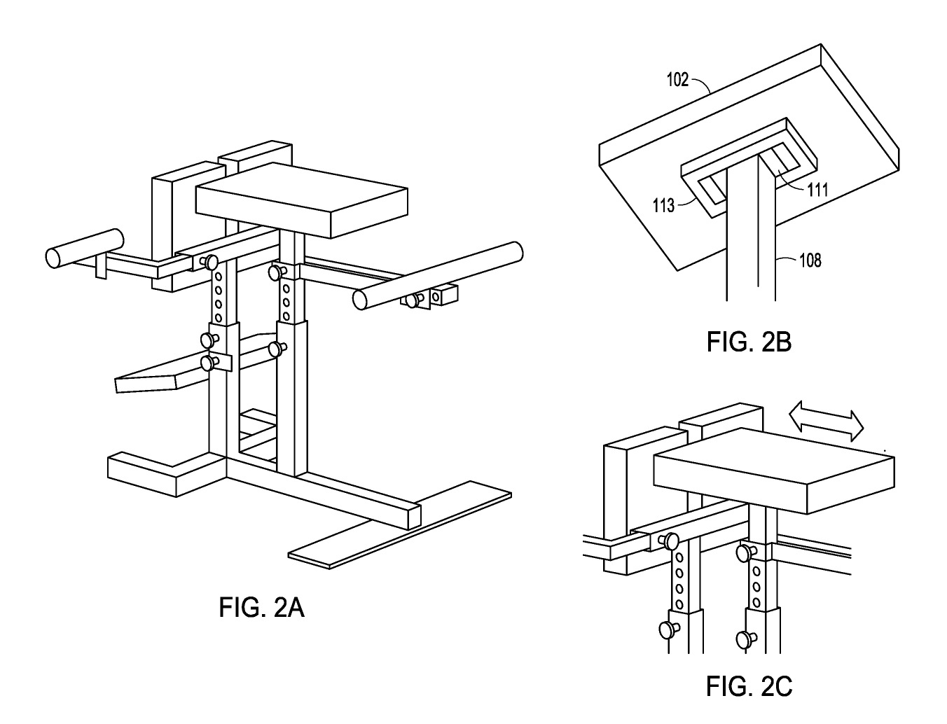

FIG. 2 shows an example of the traction apparatus 101 in which the platform 102 can be configured to allow for the platform 102 to slide horizontally or otherwise move longitudinally away from the brace 104. This can include providing an at least two-part platform 102. The platform 102 can include a base portion 111 that can be fixed with respect to the frame 100. A carriage portion 113 of the platform 102 can be mounted to the base portion 111. In an example, the carriage portion 113 can be captured by, and slidable with respect to, the base portion 111. An interface between the carriage portion 113 and the base portion 111 can include ball or roller bearings, such as can ride upon a rail that can be captured within a channel of the interface, such as to provide a sliding fit. The base 111 can be attached to the carriage 113 with the interface therebetween including an elastic member. The elastic member can provide force to the carriage 113, such as in a manner that can assist the carriage 114 to return to its original position in the absence of interaction from the user, such as between instances of applying the traction force to the user's spine. The elastic member can include one or more of a spring, an elastomeric band, or another spring-like element.

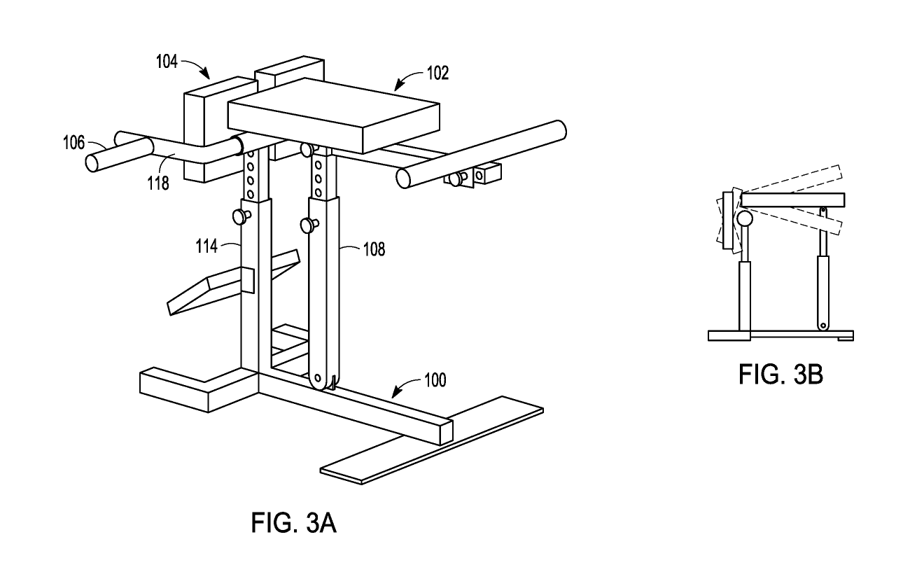

FIG. 3 shows an example of the traction apparatus 101, which can include one or more of a pivoting platform 102, a pivoting brace 104, and a pivoting frame member 118. The platform 102 can be user-adjusted to provide a position of incline or decline from a horizontal plane parallel to the ground or other surface upon which the frame 100 rests, such as an incline or decline angle that can be in a range between 0 degrees and 10 degrees, a range of 10 degrees and 20 degrees, or a range of 20 degrees to 45 degrees. For example, the platform 102 can be hingedly or otherwise pivotably attached to the frame member 108, to the frame member 114, or to both, such as using a hinge or a pivot. Additionally or alternatively, the frame member 108 or the frame member 114 can be hingedly or otherwise pivotably attached to one or more other portions of the frame 100. The desired incline or decline of the platform 102 can be achieved by the user adjusting the height of one or more of the frame members 108, 114, such as with respect to each other. In an example, the brace 104 can include a hinge or pivot, such as to permit the user to adjust an angular position of the brace 104 to a desired one of a plurality of angular positions. The brace 104 can be hingedly or otherwise pivotably attached to a portion of the frame 100, such as by a bracket to a portion of the frame member 114. The angular pivot position of the brace 104 can be fixed, such as by the user tightening a threaded bolt. This can produce friction at the bracket attaching the brace 104 to the frame member 114. For example, a plurality of holes can be located in an arcing pattern upon the bracket attaching the brace 104 to the frame member 114. A pin can be placed through a selected one of the plurality of holes, thereby fixing the angular position of the brace 104. The frame member 118 can be attached to the frame member 114 so as to allow the engagement members 106 to be positioned at a selected one of a plurality of heights relative to the platform 102. The engagement member 118 can include a tubular shape portion that can pass through a tubular bracket attached to the frame member 114 such as to provide a hinge or pivot for permitting angular adjustment. The height of the engagement members 106 can be modified by positioning the frame member 118 at an incline or decline, such as at an angle that can be in a range between 0 degrees and 45 degrees from horizontal, such as 10 degrees from horizontal, 25 degrees from horizontal, or 45 degrees from horizontal.

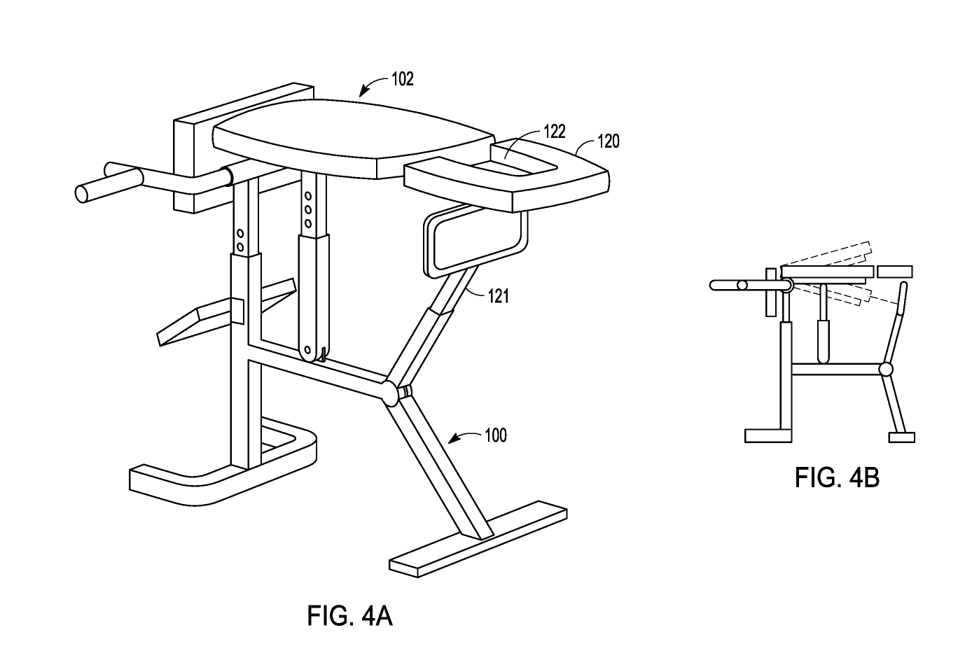

FIG. 4 shows an example of the traction apparatus 101 that can include a face rest 120. The face rest 120 can be sized, shaped, and otherwise configured to receive and support the user's head, such as when the user's upper torso is positioned on the platform 102. The face rest 120 can include a cut-out 122 that can permit an average sized user's face to rest therein. The face rest 120 can be included in or attached to the platform 102. The face rest 120 can include padding. The user's face can rest upon and engage the face rest 120, such as to position the user's face into the cut-out 122. Additionally or alternatively, the face rest 120 can attached to one or more other components, such as to the frame 100, the attachment member 108, or the attachment member 121. In an example, the face rest 122 can be attached to the platform 102 and can translate with the longitudinal movement of the platform 102, as explained elsewhere herein.

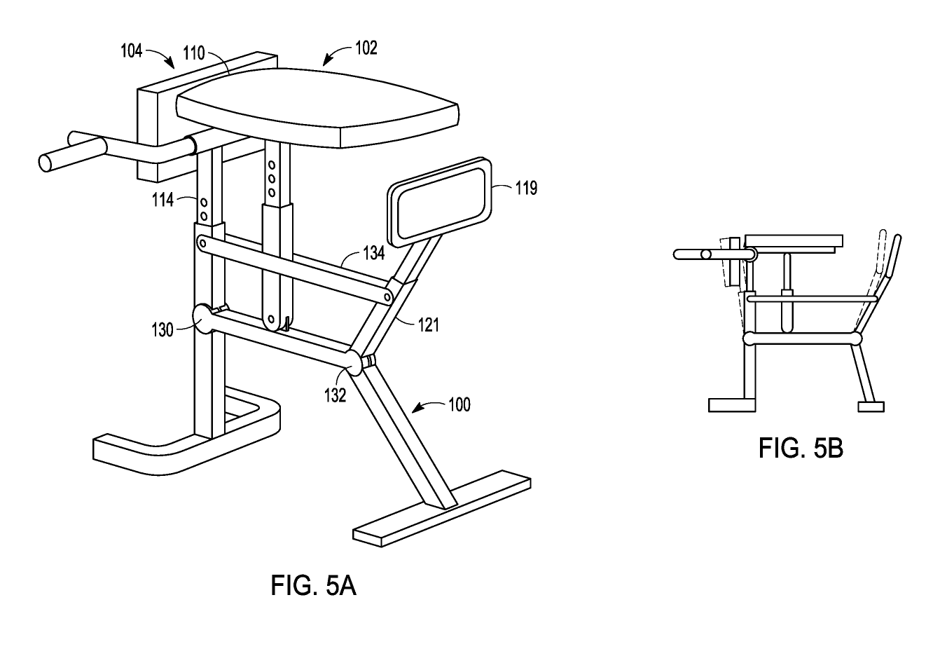

FIG. 5 shows an example in which the traction apparatus 101 can include a brace 104. In an example, the brace 104 can translate longitudinally away from the first end 110 of the platform 102. This can help provide traction to the user's spine by increasing the distance between the user's pelvis and chest when the user's upper torso is against the platform 102 and the user's pelvis is against the brace 104. In an example, the brace 104 can be displaced by a force applied by the user to the engagement member 119, which can be connected by a mechanical linkage 134 to the frame member 114, thereby displacing the brace 104 when the engagement member 119 is displaced by the user. In an example, the first end of the mechanical linkage 134 can be connected to frame member 114 such as using a pin that can be inserted into aligned holes on the frame member 114 and the mechanical linkage 134. The second end of the mechanical linkage 134 can be connected to frame member 121 in a similar fashion. To accommodate the displacement, the frame member 114 and a frame member 121 can be hingedly or pivotably attached to a portion of the frame 100. The frame 100 can include a first bracket 130 and a second bracket 132, each of which can include a hole for placing a hinge-pin therethrough. The frame member 114 and frame member 121 can include a corresponding hole located at the end that connects to the frame, such that the holes on the frame member 114 and the bracket 130 can align and the holes on frame member 121 and the bracket 132 can align. A hinge or pivot joint can be provided, such as by inserting a first pin through the aligned holes on the frame member 114 and the bracket 130 and inserting a second pin into the hole of the frame member 121, which can be aligned to the hole of the bracket 132.

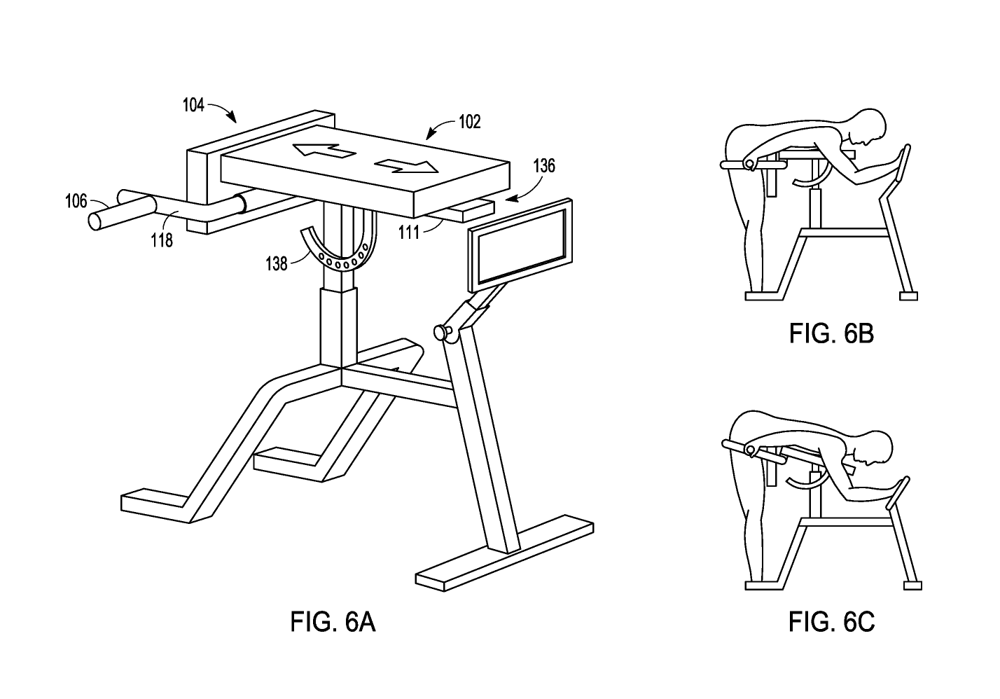

FIG. 6 shows an example in which the traction apparatus 101 can include a base assembly 136 that can include a base 111, a platform 102, a brace 104, and a frame member 118 that can include an engagement member 106 mounted thereupon. In an example, the base 111 can be adjustably connected to the frame member 118 such as to allow the user to position the base assembly 136 at an angle of incline or decline from horizontal, such as an angle from horizontal that can be within a range of between 0 degrees and 15 degrees incline or decline, a range of 15 degrees up to 30 degrees incline or decline, or a range of 30 degrees up to 45 degrees incline or decline. A semi-circular frame member 138 can be attached to the base 111. The frame member 138 can have a plurality of holes therein such as can be positioned to form an arc. The frame member 118 can have a hole located thereupon such as the hole in the frame member 118 aligns to a selected one of the plurality of holes on frame member 138 depending on the angular position of the base assembly 138. A pin can be inserted into the aligned holes within the frame member 118 and frame member 138 such as to fix the position of the base assembly 136.

Each of these non-limiting examples may stand on its own, or may be combined in various permutations or combinations with one or more of the other examples. The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A human spinal traction apparatus comprising:
a platform, extending longitudinally between first and second ends, the platform being sized, shaped, or otherwise configured to accommodate at least a portion of an average adult human user's torso resting prone upon the platform when the user's pelvis is located adjacent the first end of the platform;
a pelvic brace, positioned and oriented with respect to a first end of the platform so as to inhibit or prevent movement of the user's pelvis in a longitudinal direction along the platform when the portion of the user's torso is resting prone upon the platform; and
an upper body engagement member that is sized, shaped, or otherwise configured to engage a portion of an upper body of the user in a manner that is capable of allowing traction extending the user's spine in a longitudinal direction along the platform.

2. The apparatus of claim 1, wherein the platform is configured to move longitudinally away from the pelvic brace when the traction is applied while the platform is supporting the portion of the user's torso.

3. The apparatus of claim 1, wherein the upper body engagement member includes a handgrip that is sized, shaped, or otherwise configured to be grasped by a hand of the user while the platform is supporting the portion of the user's torso.

4. The apparatus of claim 3, wherein the handgrip is located closer to the first end of the platform than to the second end of the platform.

5. The apparatus of claim 3, wherein the handgrip is located closer to the second end of the platform than to the first end of the platform.

6. The apparatus of claim 3, wherein the handgrip includes a plurality of differently located handgrips configured to be selected for gripping by the same one of the user's hands to accommodate different arm positioning of the same user or different sized users.

7. The apparatus of claim 3, wherein the handgrip includes an adjustable position handgrip that is capable of being adjustably repositioned by a user without requiring a tool or implement to perform the repositioning.

8. The apparatus of claim 1, comprising a frame to which the platform is attached at a height above ground that is capable of accommodating the user standing adjacent the first end of the platform with at least a portion of the user's torso resting prone upon the platform with the user's pelvis located adjacent the first end of the platform against the pelvic brace.

9. The apparatus of claim 1, comprising a frame to which the platform is attached at a height above ground that is capable of accommodating the user kneeling adjacent the first end of the platform with at least a portion of the user's torso resting prone upon the platform with the user's pelvis located adjacent the first end of the platform against the pelvic brace.

10. The apparatus of claim 1, comprising a frame to which the platform is attached at a height above ground that is capable of accommodating the user suspended, with legs extended vertically downward above ground, adjacent the first end of the platform with at least a portion of the user's torso resting prone upon the platform with the user's pelvis located adjacent the first end of the platform against the pelvic brace.

11. The apparatus of claim 1, comprising a frame to which the platform is attached at a height above ground that is capable of being adjusted by the user without requiring a tool or implement to perform the adjustment.

12. The apparatus of claim 1, comprising a face rest, located closer to the second end of the platform than to the first end of the platform, the face rest sized, shaped, or otherwise configured to receive and support the user's face with at least a portion of the user's torso resting prone upon the platform with the user's pelvis located adjacent the first end of the platform against the pelvic brace.

13. The apparatus of claim 1, wherein the platform is substantially horizontal.

14. The apparatus of claim 1, wherein the platform is configured to be user-adjustable to establish or adjust an incline or decline of the platform.
